(19) United States
(12) Patent Application Publication
(10) Pub. No.: US 2023/0156724 A1
(43) Pub. Date: May 18, 2023

(54) SIGNALING DESIGN FOR TYPE II CSI-RS SPATIAL DOMAIN AND FREQUENCY DOMAIN BASIS CONFIGURATION

(71) Applicant: QUALCOMM INCORPORATED, San Diego, CA (US)

(72) Inventors: Kangqi LIU, San Diego, CA (US); Liangming WU, Beijing (CN); Chenxi HAO, Beijing (CN); Yu ZHANG, San Diego, CA (US); Min HUANG, Beijing (CN); Hao XU, Beijing (CN)

(21) Appl. No.: 17/916,953

(22) PCT Filed: May 8, 2020
(86) PCT No.: PCT/CN2020/089152

§ 371 Date: Oct. 4, 2022

(51) Int. Cl. H04W 72/23; H04B 7/0456

(52) U.S. Cl. CPC H04W 72/23; H04B 7/0456

(57) ABSTRACT

Methods, systems, and devices for wireless communications are described. The method includes receiving, from a base station, downlink control information indicating at least a portion of a frequency domain basis vector being applied by the base station for frequency domain precoding of a reference signal scheduled for transmission via a set of antenna ports, receiving, from the base station, the reference signal that is frequency domain precoded in accordance with the at least portion of the frequency domain basis vector via the set of antenna ports, and transmitting, to the base station, a report indicating an antenna port subset of the set of antenna ports and a precoding coefficient for each antenna port of the antenna port subset.

### CROSS REFERENCE

The present application is a 371 national stage filing of International PCT Application No. PCT/CN2020/089152 by LIU et al. entitled “SIGNALING DESIGN FOR TYPE II CSI-RS SPATIAL DOMAIN AND FREQUENCY DOMAIN BASIS CONFIGURATION,” filed May 8, 2020, which is assigned to the assignee hereof and which is expressly incorporated by reference in its entirety herein.

### FIELD OF TECHNOLOGY

The following relates generally to wireless communications and more specifically to signaling design for type II channel state information reference signals (CSI-RS) spatial domain and frequency domain basis configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In multiple-in multiple-out (MIMO) measurements, information may be obtained based on one or more reference signals. The reference signals may include cell specific reference signal (CRS), which provides the power/phase/timing difference measurement on up to 4 different CRS layers (antenna ports). Another reference signal is the user specific demodulation reference signal (UE-DMRS), which provides the DMRS weights per user or per resource block on different DMRS antenna ports. Another reference signal is the channel state information reference signal (CSI-RS). The CSI-RS Info Table reports a smaller set of information (power, timing, and phase) than CRS. However, unlike CRS, the CSI-RS provides channel estimation for up to 8 layers (antenna ports), which is beneficial for users that need more precise channel performance. However, in some examples, payload reporting may detrimentally impact communication throughput.

### SUMMARY

The described techniques relate to improved methods, systems, devices, and apparatuses that support signaling design for type II CSI-RS spatial domain and frequency domain basis configuration. Generally, the described techniques provide for a UE receiving, from a base station, downlink control information. The downlink control information may indicate at least a portion of a frequency domain basis vector, or a spatial domain basis vector corresponding to the frequency domain basis vector, or a linear combination coefficient vector based on the frequency domain basis vector, or any combination thereof. In some examples, the UE may receive, from the base station, a reference signal that is frequency domain precoded in accordance with the frequency domain basis vector via multiple antenna ports. In some examples, the reference signal may be spatial domain precoded in accordance with the spatial domain basis vector. In some examples, the UE may perform signal measurements of the reference signal, where each signal measurement corresponds to a respective antenna port of the multiple antenna ports. In some examples, the UE may select the antenna port subset based on the signal measurements. In some examples, the UE may transmit, to the base station, a report indicating an antenna port subset of multiple antenna ports and a precoding coefficient for each antenna port of the antenna port subset.

A method of wireless communications at a UE is described. The method may include receiving, from a base station, downlink control information indicating at least a portion of a frequency domain basis vector being applied by the base station for frequency domain precoding of a reference signal scheduled for transmission via a set of antenna ports, receiving, from the base station, the reference signal that is frequency domain precoded in accordance with the at least portion of the frequency domain basis vector via the set of antenna ports, and transmitting, to the base station, a report indicating an antenna port subset of the set of antenna ports and a precoding coefficient for each antenna port of the antenna port subset.

An apparatus for wireless communications at a UE is described. The apparatus may include a processor, memory coupled with the processor, and instructions stored in the memory. The instructions may be executable by the processor to cause the apparatus to receive, from a base station, downlink control information indicating at least a portion of a frequency domain basis vector being applied by the base station for frequency domain precoding of a reference signal scheduled for transmission via a set of antenna ports, receive, from the base station, the reference signal that is frequency domain precoded in accordance with the at least portion of the frequency domain basis vector via the set of antenna ports, and transmit, to the base station, a report indicating an antenna port subset of the set of antenna ports and a precoding coefficient for each antenna port of the antenna port subset.

Another apparatus for wireless communications at a UE is described. The apparatus may include means for receiving, from a base station, downlink control information indicating at least a portion of a frequency domain basis vector being applied by the base station for frequency domain precoding of a reference signal scheduled for transmission via a set of antenna ports, receiving, from the base station, the reference signal that is frequency domain precoded in accordance with the at least portion of the frequency domain basis vector via the set of antenna ports, and transmitting, to the base station, a report indicating an antenna port subset of the set of antenna ports and a precoding coefficient for each antenna port of the antenna port subset.

A non-transitory computer-readable medium storing code for wireless communications at a UE is described. The code may include instructions executable by a processor to receive, from a base station, downlink control information indicating at least a portion of a frequency domain basis vector being applied by the base station for frequency domain precoding of a reference signal scheduled for transmission via a set of antenna ports, receive, from the base station, the reference signal that is frequency domain precoded in accordance with the at least portion of the frequency domain basis vector via the set of antenna ports, and transmit, to the base station, a report indicating an antenna port subset of the set of antenna ports and a precoding coefficient for each antenna port of the antenna port subset.

In some examples of the method, apparatuses, and non-transitory computer-readable medium described herein, receiving the downlink control information may include operations, features, means, or instructions for receiving the downlink control information that indicates a spatial domain basis vector corresponding to the frequency domain basis vector, where the reference signal may be spatial domain precoded in accordance with the spatial domain basis vector.

In some examples of the method, apparatuses, and non-transitory computer-readable medium described herein, receiving the downlink control information may include operations, features, means, or instructions for receiving the downlink control information that indicates an index to a precoding matrix indicator table that indicates the frequency domain basis vector and the spatial domain basis vector.

In some examples of the method, apparatuses, and non-transitory computer-readable medium described herein, receiving the downlink control information may include operations, features, means, or instructions for receiving the downlink control information that indicates the entirety of the frequency domain basis vector.

In some examples of the method, apparatuses, and non-transitory computer-readable medium described herein, a remainder of the frequency domain basis vector may be preconfigured, indicated via a radio resource control message, or indicated via a medium access control (MAC) control element message.

Some examples of the method, apparatuses, and non-transitory computer-readable medium described herein may further include operations, features, means, or instructions for performing a set of signal measurements of the reference signal, where each signal measurement corresponds to respective antenna port of the set of antenna ports, and selecting the antenna port subset based on the set of signal measurements.

In some examples of the method, apparatuses, and non-transitory computer-readable medium described herein, the signal measurement includes a received signal strength indicator, or a reference signal received power, or a reference signal received quality, or a signal to noise ratio, or a signal to interference plus noise ratio, or any combination thereof.

In some examples of the method, apparatuses, and non-transitory computer-readable medium described herein, the selected antenna port subset may be layer-specific or layer-common.

In some examples of the method, apparatuses, and non-transitory computer-readable medium described herein, receiving the downlink control information further may include operations, features, means, or instructions for receiving the downlink control information that indicates a set of linear combination vectors corresponding to the frequency domain basis vector.

Some examples of the method, apparatuses, and non-transitory computer-readable medium described herein may further include operations, features, means, or instructions for determining the precoding coefficient for each antenna port of the antenna port subset based on the set of linear combination vectors indicated in the downlink control information.

Some examples of the method, apparatuses, and non-transitory computer-readable medium described herein may further include operations, features, means, or instructions for determining a reciprocity level between an uplink channel associated with the UE and a downlink channel associated with the UE.

In some examples of the method, apparatuses, and non-transitory computer-readable medium described herein, the antenna port subset may be selected based on the reciprocity level.

In some examples of the method, apparatuses, and non-transitory computer-readable medium described herein, the precoding coefficient for each antenna port of the antenna port subset may be generated based at least on part on the reciprocity level.

In some examples of the method, apparatuses, and non-transitory computer-readable medium described herein, the antenna port subset may be selected based on a basis type of the frequency domain basis vector.

In some examples of the method, apparatuses, and non-transitory computer-readable medium described herein, the basis type may be a discrete Fourier transform basis, or a singular value decomposition basis, or a discrete cosine transform basis, or a Slepian basis, or any combination thereof.

Some examples of the method, apparatuses, and non-transitory computer-readable medium described herein may further include operations, features, means, or instructions for receiving control signaling indicating a first channel precoding scheme of a set of channel precoding schemes, where the reference signal may be precoded in accordance with the first channel precoding scheme.

In some examples of the method, apparatuses, and non-transitory computer-readable medium described herein, the control signaling includes a radio resource control message, or a medium access control (MAC) control element message, or both.

A method of wireless communications at a base station is described. The method may include transmitting, to a UE, downlink control information indicating at least a portion of a frequency domain basis vector being applied by the base station for frequency domain precoding of a reference signal scheduled for transmission via a set of antenna ports, transmitting, to the UE, the reference signal that is frequency domain precoded in accordance with the at least portion of the frequency domain basis vector via the set of antenna ports, and receiving, from the UE, a report indicating an antenna port subset of the set of antenna ports and a precoding coefficient for each antenna port of the antenna port subset.

An apparatus for wireless communications at a base station is described. The apparatus may include a processor, memory coupled with the processor, and instructions stored in the memory. The instructions may be executable by the processor to cause the apparatus to transmit, to a UE, downlink control information indicating at least a portion of a frequency domain basis vector being applied by the base station for frequency domain precoding of a reference signal scheduled for transmission via a set of antenna ports, transmit, to the UE, the reference signal that is frequency domain precoded in accordance with the at least portion of the frequency domain basis vector via the set of antenna ports, and receive, from the UE, a report indicating an antenna port subset of the set of antenna ports and a precoding coefficient for each antenna port of the antenna port subset.

Another apparatus for wireless communications at a base station is described. The apparatus may include means for transmitting, to a UE, downlink control information indicating at least a portion of a frequency domain basis vector being applied by the base station for frequency domain precoding of a reference signal scheduled for transmission via a set of antenna ports, transmitting, to the UE, the reference signal that is frequency domain precoded in accordance with the at least portion of the frequency domain basis vector via the set of antenna ports, and receiving, from the UE, a report indicating an antenna port subset of the set of antenna ports and a precoding coefficient for each antenna port of the antenna port subset.

A non-transitory computer-readable medium storing code for wireless communications at a base station is described. The code may include instructions executable by a processor to transmit, to a UE, downlink control information indicating at least a portion of a frequency domain basis vector being applied by the base station for frequency domain precoding of a reference signal scheduled for transmission via a set of antenna ports, transmit, to the UE, the reference signal that is frequency domain precoded in accordance with the at least portion of the frequency domain basis vector via the set of antenna ports, and receive, from the UE, a report indicating an antenna port subset of the set of antenna ports and a precoding coefficient for each antenna port of the antenna port subset.

In some examples of the method, apparatuses, and non-transitory computer-readable medium described herein, transmitting the downlink control information may include operations, features, means, or instructions for transmitting the downlink control information that indicates a spatial domain basis vector corresponding to the frequency domain basis vector, where the reference signal may be spatial domain precoded in accordance with the spatial domain basis vector.

In some examples of the method, apparatuses, and non-transitory computer-readable medium described herein, transmitting the downlink control information may include operations, features, means, or instructions for transmitting the downlink control information that indicates an index to a precoding matrix indicator table that indicates the frequency domain basis vector and the spatial domain basis vector.

In some examples of the method, apparatuses, and non-transitory computer-readable medium described herein, transmitting the downlink control information may include operations, features, means, or instructions for transmitting the downlink control information that indicates the entirety of the frequency domain basis vector.

Some examples of the method, apparatuses, and non-transitory computer-readable medium described herein may further include operations, features, means, or instructions for generating the frequency domain basis vector using a first basis type of a set of basis types, and generating a set of linear combination vectors corresponding to the frequency domain basis vector based on the first basis type, where the downlink control information indicates the set of linear combination vectors.

In some examples of the method, apparatuses, and non-transitory computer-readable medium described herein, the set of basis types includes a discrete Fourier transform basis, or a singular value decomposition basis, or a discrete cosine transform basis, or a Slepian basis, or any combination thereof.

Some examples of the method, apparatuses, and non-transitory computer-readable medium described herein may further include operations, features, means, or instructions for generating a linear combination coefficient vector for the frequency domain basis vector, where the downlink control information indicates the linear combination coefficient vector.

In some examples of the method, apparatuses, and non-transitory computer-readable medium described herein, the linear combination coefficient vector includes a single binary bit indicating a value of one and one or more binary bits indicating a value of zero when the frequency domain basis vector may be generated using a discrete Fourier transform basis.

In some examples of the method, apparatuses, and non-transitory computer-readable medium described herein, each linear combination coefficient vector may be determined by projecting the singular value decomposition basis, or the discrete cosine transform basis, or the Slepian basis, or any combination thereof, into a space of the first basis type that may be the discrete Fourier transform basis.

Some examples of the method, apparatuses, and non-transitory computer-readable medium described herein may further include operations, features, means, or instructions for transmitting the reference signal that may be precoded in accordance with the frequency domain basis vector and a defined spatial domain basis vector.

Some examples of the method, apparatuses, and non-transitory computer-readable medium described herein may further include operations, features, means, or instructions for transmitting the reference signal that may be precoded in accordance with the portion of the frequency domain basis vector, a defined remainder frequency domain basis vector, and a defined spatial domain basis vector.

Some examples of the method, apparatuses, and non-transitory computer-readable medium described herein may further include operations, features, means, or instructions for transmitting the reference signal that may be precoded in accordance with the at least the portion of frequency domain basis vector and a spatial domain basis vector.

Some examples of the method, apparatuses, and non-transitory computer-readable medium described herein may further include operations, features, means, or instructions for transmitting control signaling indicating a first channel precoding scheme of a set of channel precoding schemes, where the reference signal may be precoded in accordance with the first channel precoding scheme.

In some examples of the method, apparatuses, and non-transitory computer-readable medium described herein, the control signaling includes a radio resource control message, or a medium access control (MAC) control element message, or both.

### BRIEF DESCRIPTION OF THE DRAWINGS

FIG. 1 illustrates an example of a system for wireless communications in accordance with one or more aspects of the present disclosure.

FIG. 2 illustrates an example of a wireless communications system in accordance with one or more aspects of the present disclosure.

FIG. 3 illustrates an example of a flow diagram in accordance with one or more aspects of the present disclosure.

FIGS. 4 and 5 show block diagrams of devices that support signaling design for type II CSI-RS spatial domain and frequency domain basis configuration in accordance with aspects of the present disclosure.

FIG. 6 shows a block diagram of a communications manager in accordance with one or more aspects of the present disclosure.

FIG. 7 shows a diagram of a system including a device in accordance with one or more aspects of the present disclosure.

FIGS. 8 and 9 show block diagrams of devices that support signaling design for type II CSI-RS spatial domain and frequency domain basis configuration in accordance with aspects of the present disclosure.

FIG. 10 shows a block diagram of a communications manager in accordance with one or more aspects of the present disclosure.

FIG. 11 shows a diagram of a system including a device in accordance with one or more aspects of the present disclosure.

FIGS. 12 through 15 show flowcharts illustrating methods that support signaling design for type II CSI-RS spatial domain and frequency domain basis configuration in accordance with aspects of the present disclosure.

### DETAILED DESCRIPTION

Wireless communications systems may include multiple communication devices such as UEs and base stations, which may provide wireless communication services to the UEs. For example, such base stations may be next-generation NodeBs or giga-NodeBs (either of which may be referred to as a gNB) that may support multiple radio access technologies including 4G systems, such as LTE systems, as well as 5G systems, which may be referred to as NR systems.

Conventional channel state information reference signal (CSI-RS) transmission is a three step process. In step 1, a UE transmit an uplink sounding reference signal (SRS) to a base station. In step 2, the base station precodes, based on a measurement of the SRS, a wideband CSI-RS signal for transmission over a set of beams via a set of antenna ports. For example, the CSI-RS signal may be precoded with a discrete Fourier transform or Eigen beams. In step 3, the UE measures CSI-RS ports, calculates a precoding matrix indicator (PMI) or channel quality indicator (CQI), or both, and reports an antenna port selection codebook to the base station. The feedback may be type-II CSI. Precoding of the CSI-RS occurs in the spatial domain or in the frequency domain, or both. Precoding of the CSI-RS may involve generating a signal using a spatial domain basis for precoding in the spatial domain, using a frequency domain basis for precoding in the frequency domain, and using a set of precoding coefficients that depend on current channel conditions.

Some payload reporting by a UE may incur significant control overhead as the number of required precoded channel state information reference signals (CSI-RS) ports over which the CSI-RS transmission is sent will increase. The number of required precoded CSI-RS ports is a function of the number of beams and a number of resource blocks over which the CSI signal is transmitted. In some examples, payload reporting may detrimentally impact communication throughput.

The conventional PMI payload reported by the UE may incur a large amount of control overhead that affects performance (e.g., decrease in downlink throughput, latency penalties, etc.). The control overhead increases as the number of precoded CSI-RS ports over which the CSI-RS transmission is sent increases from 2L to 2LM. The number of required precoded CSI-RS ports (e.g., 2LM) is a function of the number of beams (e.g., 1′ being a number of beams used for linear combination, etc.) and a number of resource blocks or a number of subbands (e.g., ‘M’ being a number of frequency domain units, etc.) over which the CSI signal is transmitted.

In the techniques described herein, downlink control information may be used to inform a UE of the frequency domain basis used to precode the CSI reference signal for transmission via a set of antenna ports. In the techniques described herein, the base station transmit control signaling to the UE via a radio resource control (RRC) message, or a medium access control (MAC) control element (CE) message, or both. In some examples, the spatial domain basis may be semi-statically predefined (e.g., signaled via RRC message or MAC-CE message) or dynamically signaled to the UE (e.g., via the downlink control information.

In some examples, techniques described herein enable a base station to configure multiple basis types at a time. The multiple basis types may include at least a discrete Fourier transform basis type, a singular value decomposition basis type, a discrete cosine transform basis, and a Slepian basis type, among other basis types. The techniques described herein enable a UE to determine the basis type based on reciprocity levels (e.g., a degree of similarity between an uplink channel associated with the UE and a downlink channel associated with the UE).

In some examples, when the UE receives the CSI-RS transmission that has been transmitted via a set of antenna ports (e.g., 2L or fewer antenna ports may be used for transmitting the CSI-RS because the UE has been signaled the frequency domain basis), the UE may determine a precoding coefficient for each of the antenna ports based on the impact the wireless channel had on the CSI-RS transmission. The UE may select a subset of the antenna ports (e.g., corresponding to the best reference signal receive power (RSRP)), and send the precoding coefficients corresponding to the selected antenna ports. The selected antenna ports, and coefficients, may be used for precoding of subsequent downlink transmissions to the UE. Because the UE is informed of the frequency domain basis by the base station, the base station may use fewer CSI-RS ports for transmitting the CSI-RS transmission, and thus the UE may report less control information after receiving the CSI-RS transmission via the reduced set of CSI-RS ports. Based on the reduced CSI-RS overhead, downlink throughput may increase.

Aspects of the disclosure are initially described in the context of wireless communications systems. Aspects of the disclosure are further illustrated by and described with reference to flow diagrams. Aspects of the disclosure are further illustrated by and described with reference to apparatus diagrams, system diagrams, and flowcharts that relate to signaling design for type II CSI-RS spatial domain and frequency domain basis configuration.

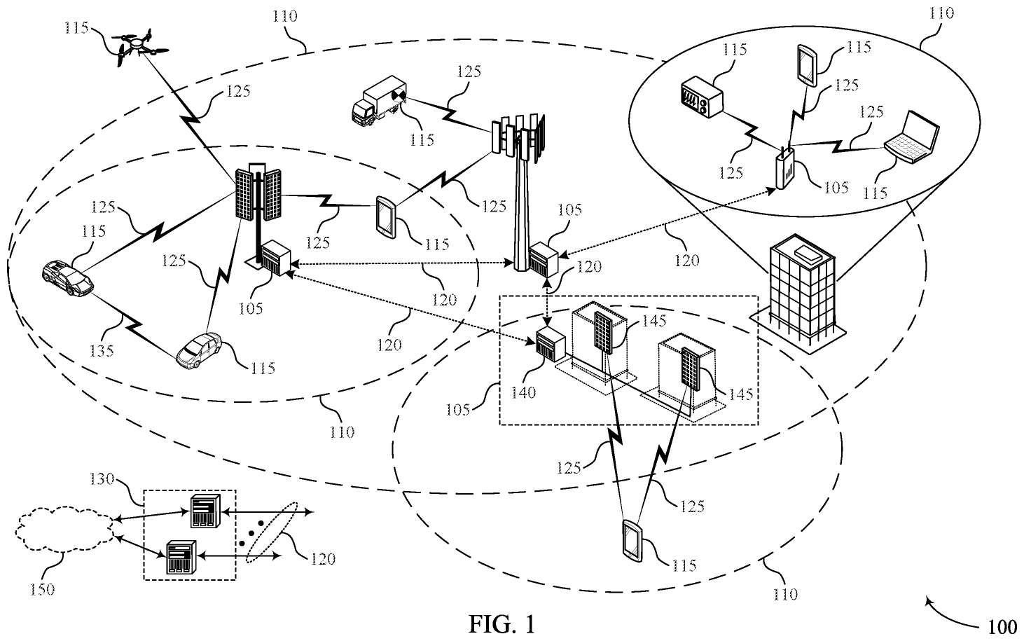

FIG. 1 illustrates an example of a wireless communications system 100 in accordance with one or more aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some examples, a UE 115 may receive, from a base station 105, downlink control information indicating a frequency domain basis vector, or a spatial domain basis vector corresponding to the frequency domain basis vector, or a linear combination coefficient based on the frequency domain basis vector, or any combination thereof. In some examples, the UE 115 may receive, from the base station 105, a reference signal that is frequency domain precoded in accordance with the frequency domain basis vector via multiple antenna ports. In some examples, the UE 115 may transmit, to the base station 105, a report indicating an antenna port subset of multiple antenna ports and a precoding coefficient for each antenna port of the antenna port subset.

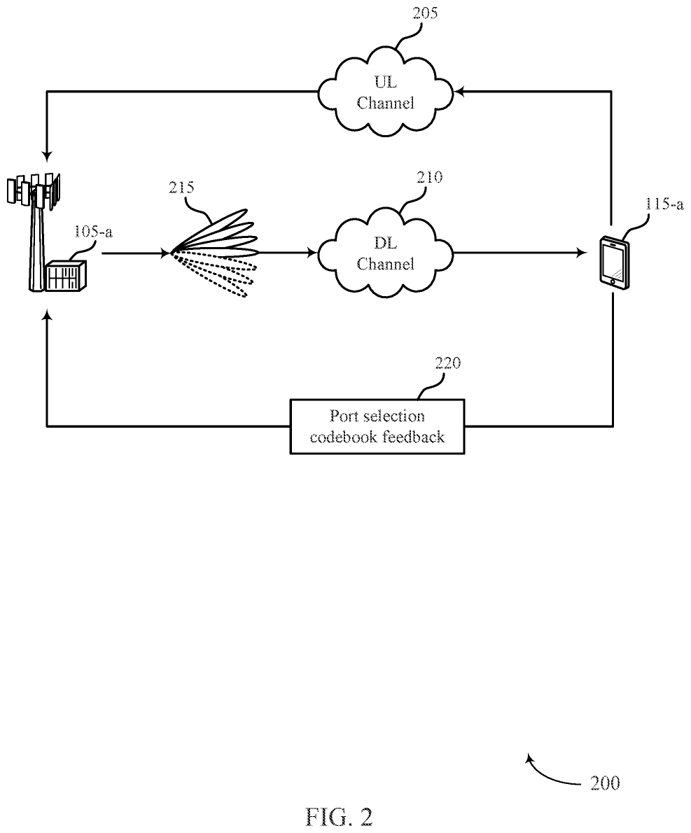

FIG. 2 illustrates an example of a wireless communications system 200 in accordance with one or more aspects of the present disclosure. In some examples, wireless communications system 200 may implement aspects of wireless communication system 100. For example, the wireless communications system 200 may support multiple radio access technologies including 4G systems such as LTE systems, LTE-A systems, or LTE-A Pro systems, and 5G systems which may be referred to as NR systems. The wireless communications system 200 may also support improvements to power consumption and, in some examples, may promote high reliability and low latency communications, as well as reduce CSI-RS overhead and increase DL throughput, among other benefits. In the illustrated example, wireless communications system 200 includes base station 105-a and UE 115-a, with uplink (UL) channel 205 and downlink (DL) channel 210.

The described techniques may include channel state feedback (CSF) for a reciprocity channel in a radio access technology (e.g., new radio (NR), NR multiple input multiple output (MIMO), etc.). In some examples, UE 115-a may transmit an UL sounding reference signal to base station 105-a. In some examples, base station 105-a may precode channel state information reference signal (CSI-RS) antenna ports (e.g., wideband CSI-RS antenna ports) based on a measurement of the sounding reference signal. The multiple antenna ports may include logical antenna ports that are distinguished by reference signal sequences. In some examples, the CSI-RS may provide channel estimation for up to 8 layers (e.g., antenna ports). In some examples, the CSI-RS may be precoded with discrete Fourier transform (DFT) or Eigen beams. In some examples, base station 105-a may transmit, to UE 115-a, a reference signal that is frequency domain precoded in accordance with at least a portion of a frequency domain basis vector via a plurality of antenna ports and physically transmitted via beams 215. In some examples, UE 115-a may measure the CSI-RS antenna ports. In some examples, UE 115-a may calculate channel quality indicator (CQI), or precoding matrix index (PMI), or rank indication (RI), or any combination thereof, based on measuring the CSI-RS antenna ports. In some examples, the UE may report an antenna port selection codebook to the base station (e.g., antenna port selection codebook feedback). In some examples, the feedback may include or be based on type II channel state information.

In some examples, base station 105-a may precode a spatial domain basis vector or a frequency domain basis vector, or both. In some examples, a type II precoder on subband n may be determined based on the following equation:

Σᵢ₌₀^{2L-1}Σₘ₌₀^{M-1}bᵢ·fₘ^{H}[n]·c_{i,m}

where bᵢ represents the spatial domain basis vector (the i-th column of W₁), fₘ^{H}[n] represents the frequency domain basis vector (the element at the m-th row, n-th column of W_{F}^{H}), and c_{i,m} represents the linear combination precoder coefficients that are determined based on a channel estimate of a wireless channel between the transmitter and receiver. In some examples, base station 105-a may determine the spatial domain basis vector bᵢ and the frequency domain basis vector fₘ^{H}[n] for each of the n subbands.

In some examples, base station 105-a may transmit at least a portion of the frequency domain basis vector to UE 115-a. In some examples, base station 105-a may transmit at least a portion of the spatial domain basis vector to UE 115-a. In some examples, base station 105-a may generate a linear combination coefficient vector for the frequency domain basis vector and may transmit the linear combination coefficient vector set to UE 115-a. In some examples, base station 105-a may transmit downlink control information indicating at least a portion of a frequency domain basis vector being applied by base station 105-a for frequency domain precoding of a reference signal scheduled for transmission via multiple antenna ports. In some examples, base station 105-a may transmit downlink control information indicating at least a portion of a frequency domain basis vector, or at least a portion of the spatial domain basis vector, or at least a portion of the linear combination coefficient vector set, or any combination thereof. In response, UE 115-a may report port selection codebook feedback 220 to base station 105-a. In some examples, UE 115-a may perform multiple signal measurements of the reference signal, where each signal measurement corresponds to a respective antenna port of the multiple of antenna ports. In some examples, UE 115-a may select the antenna port subset based at least in part on the multiple signal measurements.

In some examples, base station 105-a may emulate a number of CSI-RS antenna ports (e.g., 2LM) out of N₁N₂N₃ candidate basis. In some examples, base station 105-a may emulate 2L (M−M′+1) CSI-RS antenna ports out of N₁N₂N₃ candidate basis. In some instances, L includes a number of beams used for linear combination, M indicates a number of frequency domain basis in a set of frequency domain basis, and M′ is an integer that ranges from 0 to M−1. In some examples, an M′ portion of the set of frequency domain basis may be transmitted to UE 115-a through a downlink control information. In some examples, a M−M′ portion of the frequency domain basis may be preconfigured in UE 115-a via radio resource control message (RRC) or media access control (MAC) control element (CE) message. In some examples, N₁ may represent a number of candidate antenna ports in a first orientation, N₂ may represent a number of candidate antenna ports in a second orientation, and N₃ may represent a number of frequency domain units (e.g., a number of resource blocks n or a number of subbands n). In some examples, a CSI-RS antenna port on N₃ frequency domain units may be precoded with a determined spatial domain basis bᵢ and a determined frequency domain basis fₘ^{H}[n]. In some examples, UE 115-a may perform one or more signal measurements of the reference signal. In some examples, each signal measurement corresponds to a respective antenna port of the antenna ports base station 105-a uses to transmit the reference signal that is frequency domain precoded in accordance with the at least portion of the frequency domain basis transmitted to UE 115-a via downlink control information. In some examples, UE 115-a may select a subset of antenna ports from the antenna ports base station 105-a uses based at least in part on the signal measurements performed by UE 115-a. In some examples, UE 115-a may report the channel estimate precoding coefficients c_{i,m} associated with the selected subset of antenna ports (e.g., UE CSI feedback). The following table is an example of the various values of the spatial domain vector and frequency domain vector for respective antenna ports (e.g., Port 0, Port 1, etc.) and resource blocks (e.g., RB 0, RB 1, etc.):

| | RB 0 | RB 1 | . . . | RB N₃ − 1 |
|---|---|---|---|---|
| Port 0 | b₀ · f₀^{H}[0] | b₀ · f₀^{H}[1] | . . . | b₀ · f₀^{H}[N₃ − 1] |
| Port 1 | b₀ · f₁^{H}[0] | b₀ · f₁^{H}[1] | . . . | b₀ · f₁^{H}[N₃ − 1] |
| Port 2 | b₁ · f₀^{H}[0] | b₁ · f₀^{H}[1] | . . . | b₁ · f₀^{H}[N₃ − 1] |
| Port 3 | b₁ · f₁^{H}[0] | b₁ · f₁^{H}[1] | . . . | b₁ · f₁^{H}[N₃ − 1] |

In some examples, base station 105-a may generate the frequency domain basis vector using a first basis type of multiple basis types. In some examples, base station 105-a may generate a set of linear combination vectors corresponding to the frequency domain basis vector based on the first basis type. In some examples, the multiple basis types may include at least one of a discrete Fourier transform basis, or a singular value decomposition basis, or a discrete cosine transform basis, or a Slepian basis, or any combination thereof. In some examples, base station 105-a may generate a set of frequency domain basis. In some examples, base station 105-a may calculate the set of frequency domain basis based on the following equation:

$${f}_{m} = \frac{1}{\sqrt{N}} [ 1 , {e}^{- j \frac{2 π m \cdot 1}{N}} , … , {e}^{- j \frac{2 π m \cdot ( N - 1 )}{N}} ]$$

where m is the index of the frequency domain beamform vectors, ∈{0, 1, . . . , N−1}, and N is the number of subbands and the number of frequency domain beamform vectors.

As indicated herein, base station 105-a may generate a set of linear combination vectors corresponding to the frequency domain basis vector based on a basis type. For discrete Fourier transform, each linear combination coefficient vector may include some number of digits that include a single binary “1” and otherwise binary “0” for the others digits (e.g., [1000] for frequency domain basis f₁, [0100] for frequency domain basis f₂, etc.). For the singular value decomposition basis, or the discrete cosine transform basis, or the Slepian basis, each linear combination coefficient vector may be determined by projecting the singular value decomposition basis, or the discrete cosine transform basis, or the Slepian basis, or any combination thereof, into a space of the discrete Fourier transform basis.

In some examples, base station 105-a may indicate the set of frequency domain basis and linear combination coefficient vector set to UE 115-a (e.g., indicated in a downlink control information). In some examples, base station 105-a may determine or configure different basis types simultaneously or at the same time.

In some examples, UE 115-a may select a subset of spatial domain and frequency domain beamformed CSI-RS antenna ports and determine a respective channel estimate coefficient (e.g., precoding coefficients c_{i,m}) for each selected antenna port based on the indicated information (e.g., information indicated in a downlink control information transmitted by base station 105-a), and report the selected subset of antenna ports to base station 105-a in a CSI report message.

In some examples, the selected ports may depend on the discrete Fourier transform basis, or the singular value decomposition basis, or the discrete cosine transform basis, or the Slepian basis, or any combination thereof.

In some examples, base station 105-a may transmit the spatial domain basis vector bᵢ and the frequency domain basis vector fₘ^{H}[n] in downlink control information by using a precoding matrix indicator table. In some examples, the precoding matrix indicator table may be similar to a precoding matrix indicator table used in uplink control information. In some examples, base station 105-a may transmit the downlink control information that indicates an index to a precoding matrix indicator table that indicates the frequency domain basis vector and the spatial domain basis vector. In some examples, for each of 2L antenna ports, base station 105-a may transmit a CSI-RS transmission on each antenna port for N₃ frequency domain units (e.g., resource blocks or subbands) without precoding.

In some examples, there may be different reciprocity levels between an uplink (UL) channel (e.g., sounding reference signal (SRS) channel) associated with UE 115-a and a downlink (DL) channel associated with UE 115-a. In some examples, the reciprocity level may indicate a degree of similarity between a configuration of the UL channel and a configuration of the DL channel. In some examples, a high reciprocity level may indicate a relatively high degree of similarity between the UL channel and DL channel, while a low reciprocity level may indicate a relatively low degree of similarity between the UL channel and DL channel. In some examples, UE 115-a may determine a reciprocity level between an uplink channel associated with UE 115-a and a downlink channel associated with UE 115-a. In some examples, UE 115-a may select the subset of antenna ports based on the reciprocity level. In some examples, the precoding coefficient for each antenna port of the antenna port subset may be generated based at least on part on the reciprocity level. In some examples, when the reciprocity level is relatively low UE 115-a may have more flexibility to determine the basis type based on the information indicated by base station 105-a in downlink control information.

As indicated herein, UE 115-a may select a subset of antenna ports out of some number of ports per layer (e.g., 2L antenna ports per layer or 2LM antenna ports per layer). In some examples, the subset of antenna ports may be layer-specific or layer-common. As indicated herein, UE 115-a may report the channel estimate precoding coefficients c_{i,m} associated with the selected subset of antenna ports (e.g., UE CSI feedback).

The techniques described herein provide several options for UE 115-a to obtain the precoded channel Hₙ=bᵢ·fₘ^{H}[n]. In some examples, base station 105-a may select a channel precoding scheme among multiple channel precoding schemes and indicate the selected channel precoding scheme to UE 115-a. In some examples, base station 105-a may indicate the selected channel precoding scheme via a radio resource control message, or a medium access control (MAC) control element message, or both. In some examples, the selected channel precoding scheme may be cell-specific or UE-specific based on CSI-RS resource limitations.

In a first channel precoding scheme, UE 115-a may receive control signaling indicating the first channel precoding scheme. UE 115-a may receive, from base station 105-a, a reference signal that is frequency domain precoded in accordance with the at least portion of the frequency domain basis vector via multiple antenna ports, where the reference signal is precoded in accordance with the first channel precoding scheme. In the first channel precoding scheme, UE 115-a may be preconfigured with a spatial domain basis vector via a radio resource control message, or a medium access control (MAC) control element message, or both. In the first channel precoding scheme, 2L precoded CSI-RS antenna ports may be used. In the first channel precoding scheme, base station 105-a may indicate M frequency domain basis via downlink control information.

In a second channel precoding scheme, UE 115-a may receive control signaling indicating the second channel precoding scheme. UE 115-a may receive, from base station 105-a, a reference signal that is frequency domain precoded in accordance with the at least portion of the frequency domain basis vector via multiple antenna ports, where the reference signal is precoded in accordance with the second channel precoding scheme. In the second channel precoding scheme, UE 115-a may be preconfigured with a spatial domain basis vector via a radio resource control message, or a MAC control element message, or both. In the second channel precoding scheme, 2(M−M′+1) precoded CSI-RS antenna ports may be used. In the second channel precoding scheme, base station 105-a may indicate M′ frequency domain basis via downlink control information. In the second channel precoding scheme, UE 115-a may be preconfigured with M−M′ frequency domain basis vector via a radio resource control message, or a MAC control element message, or both.

In a third channel precoding scheme, UE 115-a may receive control signaling indicating the third channel precoding scheme. UE 115-a may receive, from base station 105-a, a reference signal that is frequency domain precoded in accordance with the at least portion of the frequency domain basis vector via multiple antenna ports, where the reference signal is precoded in accordance with the third channel precoding scheme. In the third channel precoding scheme, UE 115-a may be preconfigured with at least a portion of the frequency domain basis vector, or a spatial domain basis vector, or both, via a radio resource control message, or a medium access control (MAC) control element message, or both. In the third channel precoding scheme, 2L or 2(M−M′+1) precoded CSI-RS antenna ports may be used. In the third channel precoding scheme, base station 105-a may indicate M frequency domain basis via downlink control information. In the third channel precoding scheme, base station 105-a may indicate at least a portion of the linear combination coefficient vector set corresponding to the frequency domain basis vector. In the third channel precoding scheme, base station 105-a may indicate at least a portion of a frequency domain basis vector, or at least a portion of the spatial domain basis vector, or at least a portion of the linear combination coefficient vector set, or any combination thereof, via a downlink control information transmitted to UE 115-a.

In a fourth channel precoding scheme, base station 105-a may use unprecoded CSI-RS antenna ports. In the fourth channel precoding scheme, base station 105-a may indicate the frequency domain basis vector, the spatial domain basis vector, and the linear combination coefficient vector set via a downlink control information transmitted to UE 115-a. As discussed above, for DFT basis, each linear combination coefficient vector may contain only one “1” and “0” for others. For SVD/DCT/Slepian basis, each linear combination coefficient vector may be obtained by projecting the SVD/DCT/Slepian basis into the space of DFT basis.

The multiple channel precoding schemes provide several advantages to base station 105-a or UE 115-a, or both. Among other advantages, the multiple channel precoding schemes reduce CSI-RS overhead for UE 115-a or base station, or both. The multiple channel precoding schemes increase DL throughput for UE 115-a or base station, or both. The multiple channel precoding schemes enable base station 105-a to configure different basis types at a time. The multiple channel precoding schemes enable UE 115-a to determine the basis type based on a determined reciprocity level.

By supporting signaling for type II channel state information reference signals associated with spatial domain and frequency domain configuration, base station 105-a and UE 115-a may experience power savings, reduced CSI-RS overhead, and increased DL throughput, among other benefits.

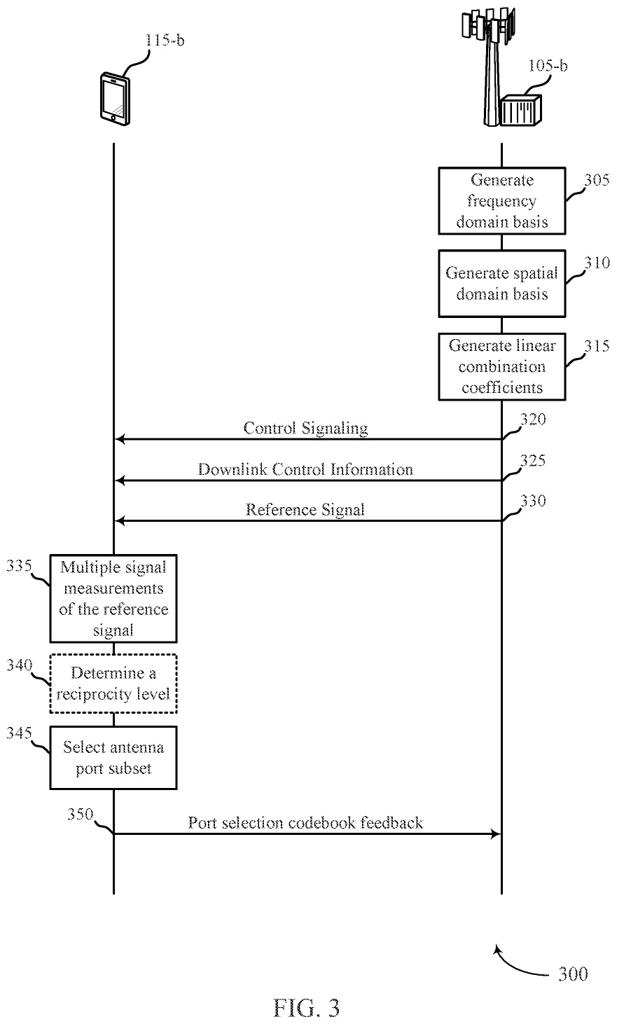

FIG. 3 illustrates an example of a flow diagram 300 in accordance with one or more aspects of the present disclosure. In some examples, flow diagram 300 may implement aspects of wireless communication system 100. In the example illustrated in FIG. 3, the flow diagram 300 may include base station 105-b and UE 115-b. In some examples, the flow diagram 300 may be based on a configuration by UE 115-b or base station 105-b, or both, and may be implemented by UE 115-b and base station 105-b. The wireless communications system 300 may also support improvements to power consumption and, in some examples, may promote high reliability and low latency communications, as well as reduce CSI-RS overhead and increase DL throughput, among other benefits.

At 305, base station 105-b may generate the frequency domain basis vector. In some examples, base station 105-b may generate the frequency domain basis vector using a first basis type of multiple basis types. In some examples, the multiple basis types may include a discrete Fourier transform basis, or a singular value decomposition basis, or a discrete cosine transform basis, or a Slepian basis, or any combination thereof.

At 310, base station 105-b may generate a spatial domain basis vector. In some examples, the spatial domain basis vector may be based on or correspond to the frequency domain basis vector of 305.

At 315, base station 105-b may generate linear combination coefficients corresponding to the frequency domain basis vector. In some examples, base station 105-b may generate a set of linear combination vectors corresponding to the frequency domain basis vector based at least in part on the first basis type. In some instances, the linear combination coefficient vector may include a single a binary bit indicating a value of binary 1 and one or more binary bits indicating a value of binary 0 when the frequency domain basis vector is generated using a discrete Fourier transform basis.

At 320, base station 105-b may transmit control signaling to UE 115-b via a radio resource control (RRC) message, or a medium access control (MAC) control element (CE) message, or both. In some examples, base station 105-b may indicate a channel precoding scheme of multiple channel precoding schemes via the control signaling of 320. In some examples, base station 105-b may optionally indicate a portion of the frequency domain basis vector via the control signaling of 320. In some examples, base station 105-b may optionally indicate a portion of the spatial domain basis via the control signaling of 320. In some examples, base station 105-b may optionally indicate a portion of the linear combination coefficients via the control signaling of 320.

At 325, base station 105-b may transmit, to UE 115-b, downlink control information indicating at least a portion of the frequency domain basis vector being applied by base station 105-b for frequency domain precoding of a reference signal scheduled for transmission via multiple antenna ports of base station 105-b. In some instances, the downlink control information may indicate the spatial domain basis vector corresponding to the frequency domain basis vector. In some instances, the downlink control information may indicate an index to a precoding matrix indicator table that indicates the frequency domain basis vector and the spatial domain basis vector. In some instances, the downlink control information may indicate a portion of the frequency domain basis vector while the remainder of the frequency domain basis vector may be indicated in the control signaling of 320. In some instances, the downlink control information may indicate the entirety of the frequency domain basis vector. In some instances, the downlink control information indicates the set of linear combination vectors of 315.

At 330, base station 105-b may transmit a reference signal to UE 115-b. In some examples, the reference signal may be precoded in accordance with the frequency domain basis vector and a defined spatial domain basis vector (e.g., defined by the control signaling of 320). In some examples, the reference signal may be precoded in accordance with a portion of the frequency domain basis vector, a defined remainder frequency domain basis vector (e.g., defined by the control signaling of 320), and a defined spatial domain basis vector (e.g., defined by the control signaling of 320). In some examples, the reference signal may be precoded in accordance with the at least the portion of frequency domain basis vector and a spatial domain basis vector. In some instances, the reference signal may be precoded in accordance with a first channel precoding scheme. In some instances, the reference signal may be spatial domain precoded in accordance with the spatial domain basis vector.

At 335, UE 115-b may perform multiple signal measurements of the reference signal of 330. In some examples, each signal measurement performed by UE 115-b may correspond to a respective antenna port of the multiple antenna ports.

At 340, UE 115-b may optionally determine a reciprocity level between an uplink channel and a downlink channel associated with associated with UE 115-b and the base station 105-b.

At 345, UE 115-b may select an antenna port subset (e.g., one or more antenna ports of the multiple antenna ports) based on the signal measurements of the multiple antenna ports. In some examples, UE 115-b may select the antenna port subset based on the reciprocity level of 340. In some examples, the selected antenna port subset may be layer-specific or layer-common.

At 350, UE 115-b may transmit, to base station 105-b, a report (e.g., CSI report, port selection codebook feedback) indicating the selected antenna port subset of the multiple antenna ports and a precoding coefficient (e.g., c_{i,m}) for each antenna port of the antenna port subset. The base station 105-b may use the precoding coefficient for subsequent downlink transmissions (e.g., beamformed transmissions) to the UE 115-b to account for the wireless channel therebetween.

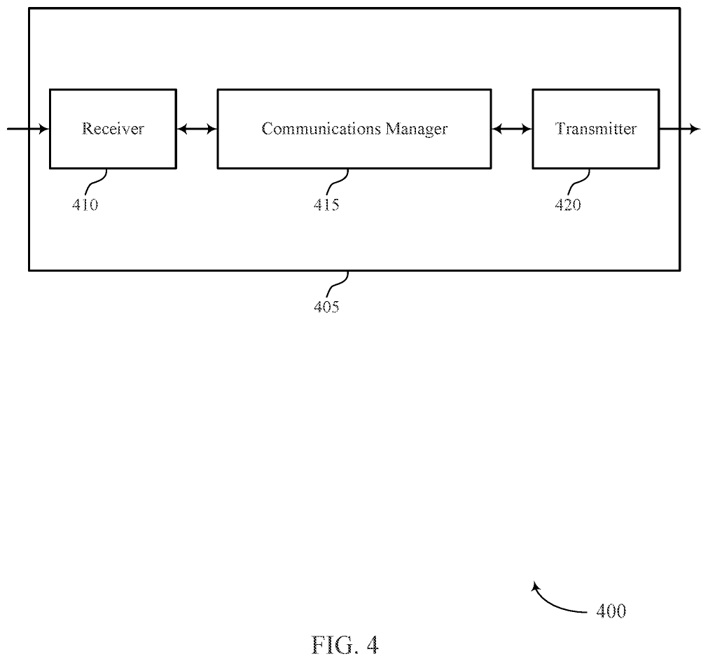

FIG. 4 shows a block diagram 400 of a device 405 in accordance with one or more aspects of the present disclosure. The device 405 may be an example of aspects of a UE 115 as described herein. The device 405 may include a receiver 410, a communications manager 415, and a transmitter 420. The device 405 may also include a processor. Each of these components may be in communication with one another (e.g., via one or more buses).

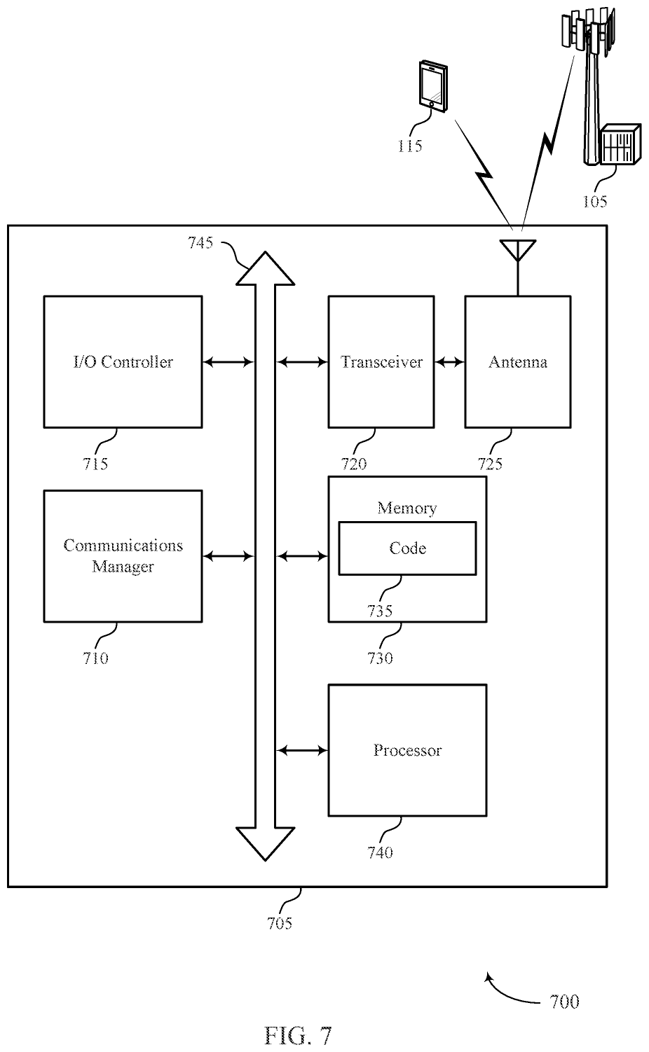

The receiver 410 may receive information such as packets, user data, or control information associated with various information channels (e.g., control channels, data channels, and information related to signaling design for type II CSI-RS spatial domain and frequency domain basis configuration, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may receive, from a base station, downlink control information indicating at least a portion of a frequency domain basis vector being applied by the base station for frequency domain precoding of a reference signal scheduled for transmission via a set of antenna ports, receive, from the base station, the reference signal that is frequency domain precoded in accordance with the at least portion of the frequency domain basis vector via the set of antenna ports, and transmit, to the base station, a report indicating an antenna port subset of the set of antenna ports and a precoding coefficient for each antenna port of the antenna port subset. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

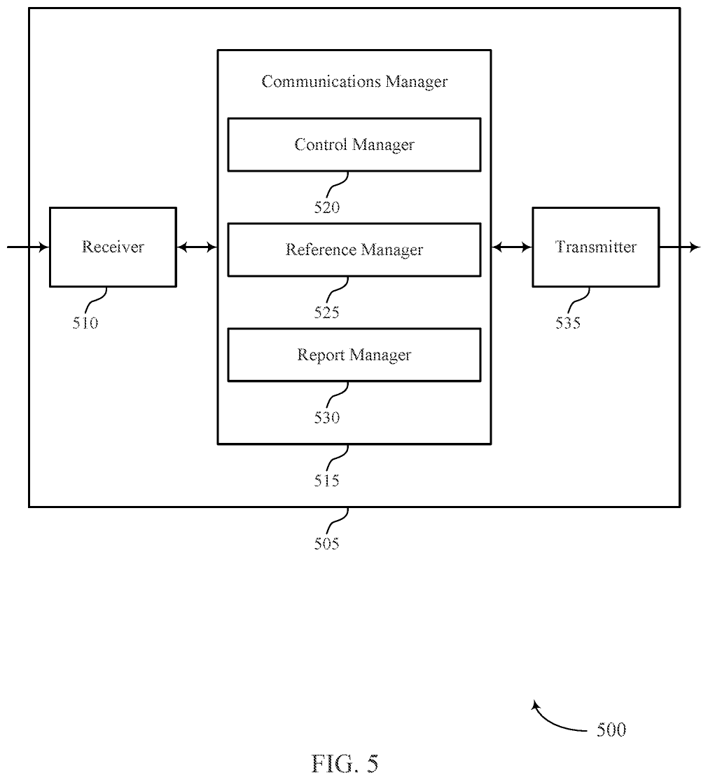

FIG. 5 shows a block diagram 500 of a device 505 in accordance with one or more aspects of the present disclosure. The device 505 may be an example of aspects of a device 405, or a UE 115 as described herein. The device 505 may include a receiver 510, a communications manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to signaling design for type II CSI-RS spatial domain and frequency domain basis configuration, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a control manager 520, a reference manager 525, and a report manager 530. The communications manager 515 may be an example of aspects of the communications manager 710 described herein.

The control manager 520 may receive, from a base station, downlink control information indicating at least a portion of a frequency domain basis vector being applied by the base station for frequency domain precoding of a reference signal scheduled for transmission via a set of antenna ports.

The reference manager 525 may receive, from the base station, the reference signal that is frequency domain precoded in accordance with the at least portion of the frequency domain basis vector via the set of antenna ports.

The report manager 530 may transmit, to the base station, a report indicating an antenna port subset of the set of antenna ports and a precoding coefficient for each antenna port of the antenna port subset.

The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

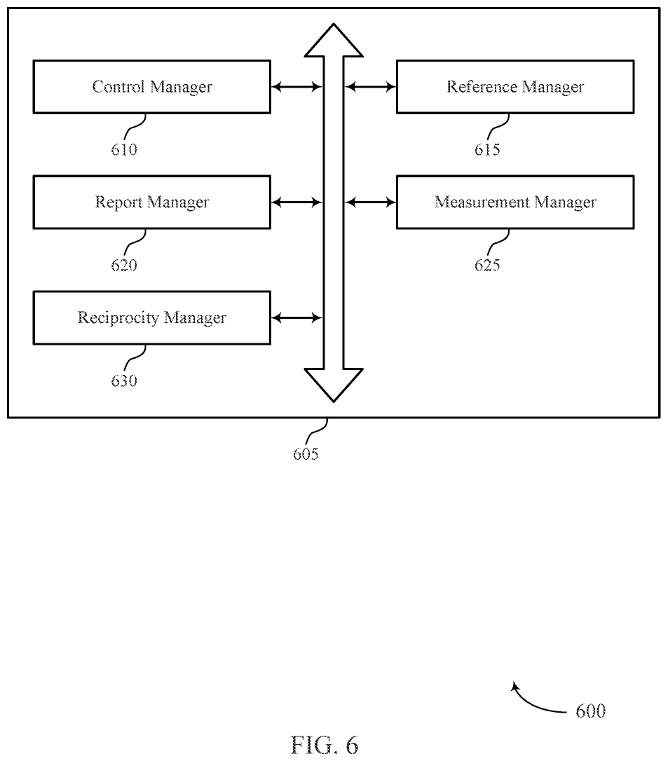

FIG. 6 shows a block diagram 600 of a communications manager 605 in accordance with one or more aspects of the present disclosure. The communications manager 605 may be an example of aspects of a communications manager 415, a communications manager 515, or a communications manager 710 described herein. The communications manager 605 may include a control manager 610, a reference manager 615, a report manager 620, a measurement manager 625, and a reciprocity manager 630. Each of these modules may communicate, directly or indirectly, with one another (e.g., via one or more buses).

The control manager 610 may receive, from a base station, downlink control information indicating at least a portion of a frequency domain basis vector being applied by the base station for frequency domain precoding of a reference signal scheduled for transmission via a set of antenna ports.

In some examples, the control manager 610 may receive the downlink control information that indicates a spatial domain basis vector corresponding to the frequency domain basis vector, where the reference signal is spatial domain precoded in accordance with the spatial domain basis vector.

In some examples, the control manager 610 may receive the downlink control information that indicates an index to a precoding matrix indicator table that indicates the frequency domain basis vector and the spatial domain basis vector. In some examples, the control manager 610 may receive the downlink control information that indicates the entirety of the frequency domain basis vector. In some examples, the control manager 610 may receive the downlink control information that indicates a set of linear combination vectors corresponding to the frequency domain basis vector.

In some examples, the control manager 610 may determine the precoding coefficient for each antenna port of the antenna port subset based on the set of linear combination vectors indicated in the downlink control information. In some examples, the control manager 610 may receive control signaling indicating a first channel precoding scheme of a set of channel precoding schemes, where the reference signal is precoded in accordance with the first channel precoding scheme. In some cases, a remainder of the frequency domain basis vector is preconfigured, indicated via a radio resource control message, or indicated via a medium access control (MAC) control element message.

In some cases, the control signaling includes a radio resource control message, or a medium access control (MAC) control element message, or both.

The reference manager 615 may receive, from the base station, the reference signal that is frequency domain precoded in accordance with the at least portion of the frequency domain basis vector via the set of antenna ports.

The report manager 620 may transmit, to the base station, a report indicating an antenna port subset of the set of antenna ports and a precoding coefficient for each antenna port of the antenna port subset. In some cases, the selected antenna port subset are layer-specific or layer-common. In some cases, the antenna port subset is selected based on a basis type of the frequency domain basis vector. In some cases, the basis type is a discrete Fourier transform basis, or a singular value decomposition basis, or a discrete cosine transform basis, or a Slepian basis, or any combination thereof.

The measurement manager 625 may perform a set of signal measurements of the reference signal, where each signal measurement corresponds to respective antenna port of the set of antenna ports. In some examples, the measurement manager 625 may select the antenna port subset based on the set of signal measurements. In some cases, the signal measurement includes a received signal strength indicator, or a reference signal received power, or a reference signal received quality, or a signal to noise ratio, or a signal to interference plus noise ratio, or any combination thereof.

The reciprocity manager 630 may determine a reciprocity level between an uplink channel associated with the UE and a downlink channel associated with the UE. In some cases, the antenna port subset is selected based on the reciprocity level. In some cases, the precoding coefficient for each antenna port of the antenna port subset is generated based at least on part on the reciprocity level.

FIG. 7 shows a diagram of a system 700 including a device 705 in accordance with one or more aspects of the present disclosure. The device 705 may be an example of or include the components of device 405, device 505, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may receive, from a base station, downlink control information indicating at least a portion of a frequency domain basis vector being applied by the base station for frequency domain precoding of a reference signal scheduled for transmission via a set of antenna ports, receive, from the base station, the reference signal that is frequency domain precoded in accordance with the at least portion of the frequency domain basis vector via the set of antenna ports, and transmit, to the base station, a report indicating an antenna port subset of the set of antenna ports and a precoding coefficient for each antenna port of the antenna port subset.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting signaling design for type II CSI-RS spatial domain and frequency domain basis configuration).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

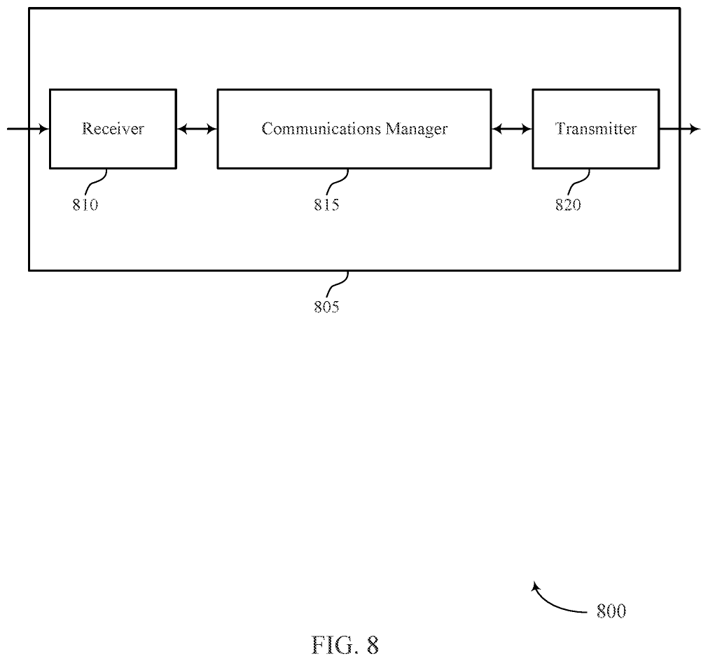

FIG. 8 shows a block diagram 800 of a device 805 in accordance with one or more aspects of the present disclosure. The device 805 may be an example of aspects of a base station 105 as described herein. The device 805 may include a receiver 810, a communications manager 815, and a transmitter 820. The device 805 may also include a processor. Each of these components may be in communication with one another (e.g., via one or more buses).

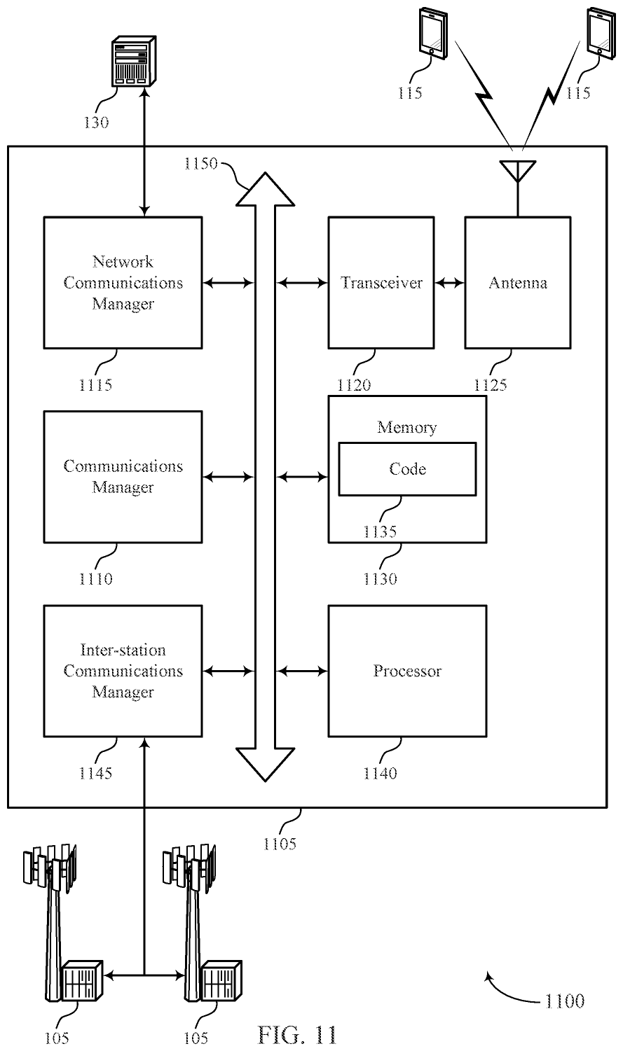

The receiver 810 may receive information such as packets, user data, or control information associated with various information channels (e.g., control channels, data channels, and information related to signaling design for type II CSI-RS spatial domain and frequency domain basis configuration, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may transmit, to a UE, downlink control information indicating at least a portion of a frequency domain basis vector being applied by the base station for frequency domain precoding of a reference signal scheduled for transmission via a set of antenna ports, transmit, to the UE, the reference signal that is frequency domain precoded in accordance with the at least portion of the frequency domain basis vector via the set of antenna ports, and receive, from the UE, a report indicating an antenna port subset of the set of antenna ports and a precoding coefficient for each antenna port of the antenna port subset. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

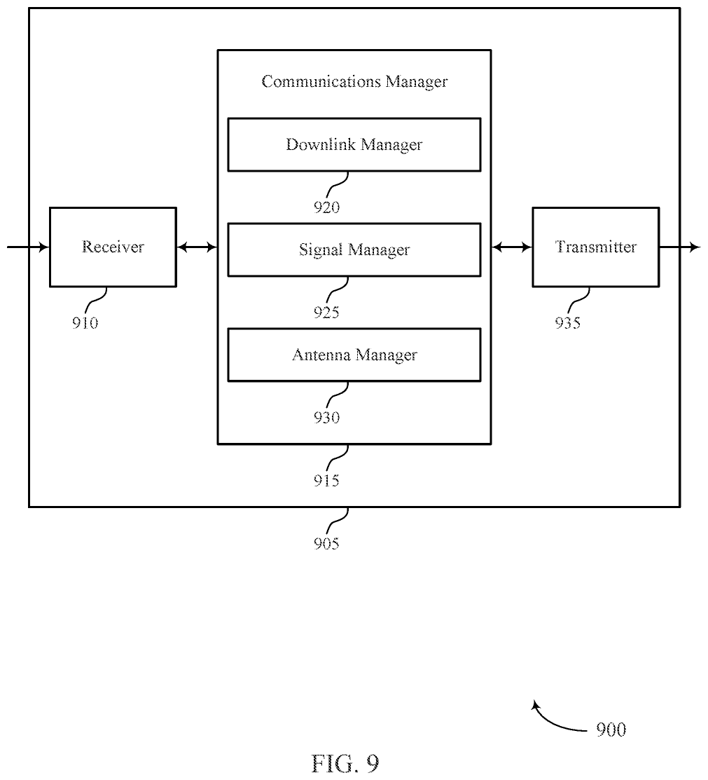

FIG. 9 shows a block diagram 900 of a device 905 in accordance with one or more aspects of the present disclosure. The device 905 may be an example of aspects of a device 805, or a base station 105 as described herein. The device 905 may include a receiver 910, a communications manager 915, and a transmitter 935. The device 905 may also include a processor. Each of these components may be in communication with one another (e.g., via one or more buses).

The receiver 910 may receive information such as packets, user data, or control information associated with various information channels (e.g., control channels, data channels, and information related to signaling design for type II CSI-RS spatial domain and frequency domain basis configuration, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a downlink manager 920, a signal manager 925, and an antenna manager 930. The communications manager 915 may be an example of aspects of the communications manager 1110 described herein.

The downlink manager 920 may transmit, to a UE, downlink control information indicating at least a portion of a frequency domain basis vector being applied by the base station for frequency domain precoding of a reference signal scheduled for transmission via a set of antenna ports.

The signal manager 925 may transmit, to the UE, the reference signal that is frequency domain precoded in accordance with the at least portion of the frequency domain basis vector via the set of antenna ports.

The antenna manager 930 may receive, from the UE, a report indicating an antenna port subset of the set of antenna ports and a precoding coefficient for each antenna port of the antenna port subset.

The transmitter 935 may transmit signals generated by other components of the device 905. In some examples, the transmitter 935 may be collocated with a receiver 910 in a transceiver module. For example, the transmitter 935 may be an example of aspects of the transceiver 1120 described with reference to FIG. 11. The transmitter 935 may utilize a single antenna or a set of antennas.

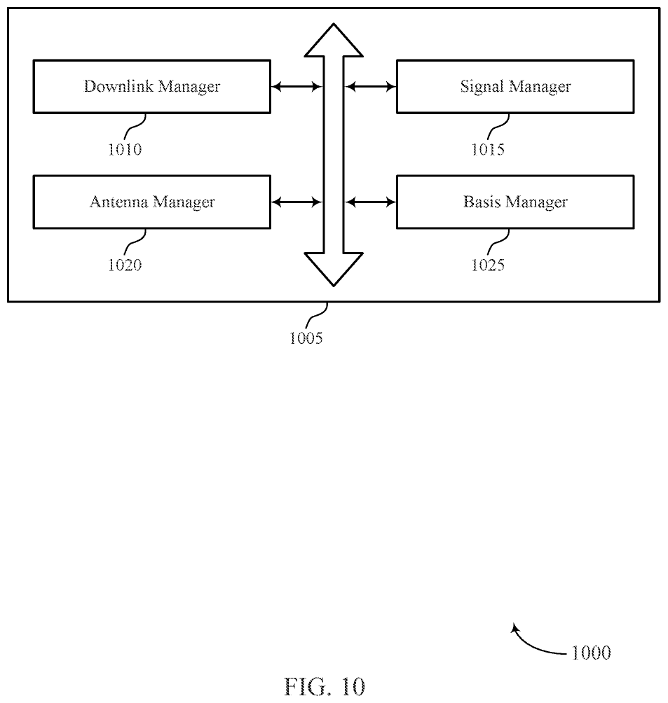

FIG. 10 shows a block diagram 1000 of a communications manager 1005 in accordance with one or more aspects of the present disclosure. The communications manager 1005 may be an example of aspects of a communications manager 815, a communications manager 915, or a communications manager 1110 described herein. The communications manager 1005 may include a downlink manager 1010, a signal manager 1015, an antenna manager 1020, and a basis manager 1025. Each of these modules may communicate, directly or indirectly, with one another (e.g., via one or more buses).

The downlink manager 1010 may transmit, to a UE, downlink control information indicating at least a portion of a frequency domain basis vector being applied by the base station for frequency domain precoding of a reference signal scheduled for transmission via a set of antenna ports.

In some examples, the downlink manager 1010 may transmit the downlink control information that indicates a spatial domain basis vector corresponding to the frequency domain basis vector, where the reference signal is spatial domain precoded in accordance with the spatial domain basis vector.

In some examples, the downlink manager 1010 may transmit the downlink control information that indicates an index to a precoding matrix indicator table that indicates the frequency domain basis vector and the spatial domain basis vector.

In some examples, the downlink manager 1010 may transmit the downlink control information that indicates the entirety of the frequency domain basis vector.

The signal manager 1015 may transmit, to the UE, the reference signal that is frequency domain precoded in accordance with the at least portion of the frequency domain basis vector via the set of antenna ports.

In some examples, the signal manager 1015 may transmit the reference signal that is precoded in accordance with the frequency domain basis vector and a defined spatial domain basis vector.

In some examples, the signal manager 1015 may transmit the reference signal that is precoded in accordance with the portion of the frequency domain basis vector, a defined remainder frequency domain basis vector, and a defined spatial domain basis vector.

In some examples, the signal manager 1015 may transmit the reference signal that is precoded in accordance with the at least the portion of frequency domain basis vector and a spatial domain basis vector.

In some examples, the signal manager 1015 may transmit control signaling indicating a first channel precoding scheme of a set of channel precoding schemes, where the reference signal is precoded in accordance with the first channel precoding scheme.

In some cases, the control signaling includes a radio resource control message, or a medium access control (MAC) control element message, or both.

The antenna manager 1020 may receive, from the UE, a report indicating an antenna port subset of the set of antenna ports and a precoding coefficient for each antenna port of the antenna port subset.

The basis manager 1025 may generate the frequency domain basis vector using a first basis type of a set of basis types.

In some examples, the basis manager 1025 may generate a set of linear combination vectors corresponding to the frequency domain basis vector based on the first basis type, where the downlink control information indicates the set of linear combination vectors.

In some examples, the basis manager 1025 may generate a linear combination coefficient vector for the frequency domain basis vector, where the downlink control information indicates the linear combination coefficient vector.

In some cases, the set of basis types includes a discrete Fourier transform basis, or a singular value decomposition basis, or a discrete cosine transform basis, or a Slepian basis, or any combination thereof.

In some cases, the linear combination coefficient vector includes a single binary bit indicating a value of one and one or more binary bits indicating a value of zero when the frequency domain basis vector is generated using a discrete Fourier transform basis.

In some cases, each linear combination coefficient vector is determined by projecting the singular value decomposition basis, or the discrete cosine transform basis, or the Slepian basis, or any combination thereof, into a space of the first basis type that is the discrete Fourier transform basis.

FIG. 11 shows a diagram of a system 1100 including a device 1105 in accordance with one or more aspects of the present disclosure. The device 1105 may be an example of or include the components of device 805, device 905, or a base station 105 as described herein. The device 1105 may include components for bi-directional voice and data communications including components for transmitting and receiving communications, including a communications manager 1110, a network communications manager 1115, a transceiver 1120, an antenna 1125, memory 1130, a processor 1140, and an inter-station communications manager 1145. These components may be in electronic communication via one or more buses (e.g., bus 1150).

The communications manager 1110 may transmit, to a UE, downlink control information indicating at least a portion of a frequency domain basis vector being applied by the base station for frequency domain precoding of a reference signal scheduled for transmission via a set of antenna ports, transmit, to the UE, the reference signal that is frequency domain precoded in accordance with the at least portion of the frequency domain basis vector via the set of antenna ports, and receive, from the UE, a report indicating an antenna port subset of the set of antenna ports and a precoding coefficient for each antenna port of the antenna port subset.

The network communications manager 1115 may manage communications with the core network (e.g., via one or more wired backhaul links). For example, the network communications manager 1115 may manage the transfer of data communications for client devices, such as one or more UEs 115.

The transceiver 1120 may communicate bi-directionally, via one or more antennas, wired, or wireless links as described herein. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM, ROM, or a combination thereof. The memory 1130 may store computer-readable code 1135 including instructions that, when executed by a processor (e.g., the processor 1140) cause the device to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some cases, a memory controller may be integrated into processor 1140. The processor 1140 may be configured to execute computer-readable instructions stored in a memory (e.g., the memory 1130) to cause the device 1105 to perform various functions (e.g., functions or tasks supporting signaling design for type II CSI-RS spatial domain and frequency domain basis configuration).

The inter-station communications manager 1145 may manage communications with other base station 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communication network technology to provide communication between base stations 105.

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

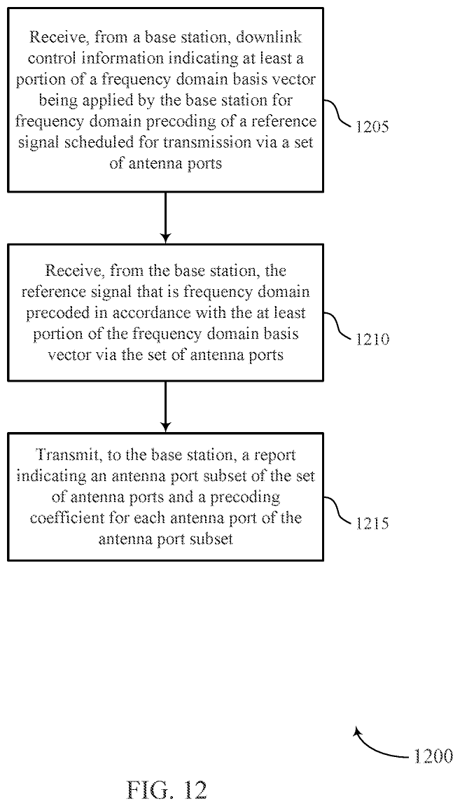

FIG. 12 shows a flowchart illustrating a method 1200 in accordance with one or more aspects of the present disclosure. The operations of method 1200 may be implemented by a UE 115 or its components as described herein. For example, the operations of method 1200 may be performed by a communications manager as described with reference to FIGS. 4 through 7. In some examples, a UE may execute a set of instructions to control the functional elements of the UE to perform the functions described herein. Additionally or alternatively, a UE may perform aspects of the functions described herein using special-purpose hardware.

At 1205, the UE may receive, from a base station, downlink control information indicating at least a portion of a frequency domain basis vector being applied by the base station for frequency domain precoding of a reference signal scheduled for transmission via a set of antenna ports. The operations of 1205 may be performed according to the methods described herein. In some examples, aspects of the operations of 1205 may be performed by a control manager as described with reference to FIGS. 4 through 7. Additionally or alternatively, means for performing 1205 may, but not necessarily, include, for example, antenna 725, transceiver 720, communications manager 710, memory 730 (including code 735), processor 740 and/or bus 745.

At 1210, the UE may receive, from the base station, the reference signal that is frequency domain precoded in accordance with the at least portion of the frequency domain basis vector via the set of antenna ports. The operations of 1210 may be performed according to the methods described herein. In some examples, aspects of the operations of 1210 may be performed by a reference manager as described with reference to FIGS. 4 through 7. Additionally or alternatively, means for performing 1210 may, but not necessarily, include, for example, antenna 725, transceiver 720, communications manager 710, memory 730 (including code 735), processor 740 and/or bus 745.

At 1215, the UE may transmit, to the base station, a report indicating an antenna port subset of the set of antenna ports and a precoding coefficient for each antenna port of the antenna port subset. The operations of 1215 may be performed according to the methods described herein. In some examples, aspects of the operations of 1215 may be performed by a report manager as described with reference to FIGS. 4 through 7. Additionally or alternatively, means for performing 1215 may, but not necessarily, include, for example, antenna 725, transceiver 720, communications manager 710, memory 730 (including code 735), processor 740 and/or bus 745.

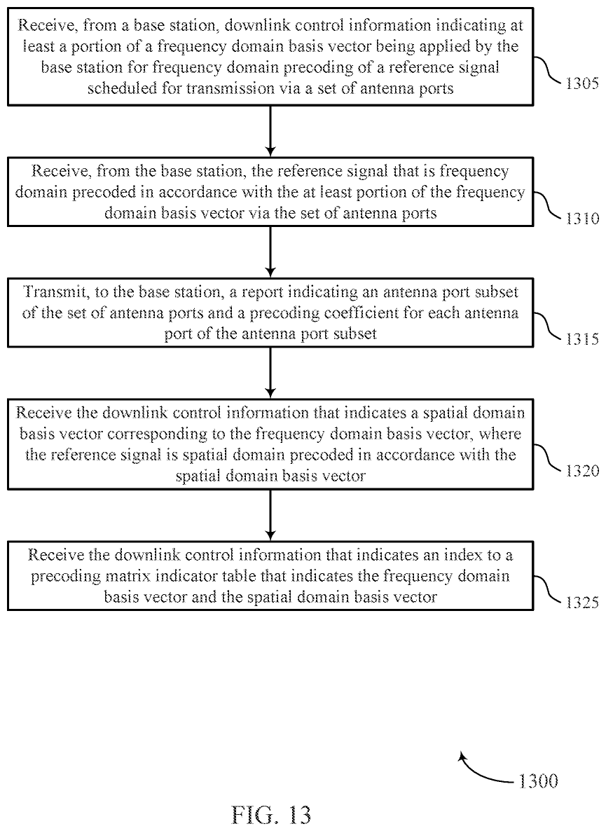

FIG. 13 shows a flowchart illustrating a method 1300 in accordance with one or more aspects of the present disclosure. The operations of method 1300 may be implemented by a UE 115 or its components as described herein. For example, the operations of method 1300 may be performed by a communications manager as described with reference to FIGS. 4 through 7. In some examples, a UE may execute a set of instructions to control the functional elements of the UE to perform the functions described herein. Additionally or alternatively, a UE may perform aspects of the functions described herein using special-purpose hardware.

At 1305, the UE may receive, from a base station, downlink control information indicating at least a portion of a frequency domain basis vector being applied by the base station for frequency domain precoding of a reference signal scheduled for transmission via a set of antenna ports. The operations of 1305 may be performed according to the methods described herein. In some examples, aspects of the operations of 1305 may be performed by a control manager as described with reference to FIGS. 4 through 7. Additionally or alternatively, means for performing 1305 may, but not necessarily, include, for example, antenna 725, transceiver 720, communications manager 710, memory 730 (including code 735), processor 740 and/or bus 745.

At 1310, the UE may receive, from the base station, the reference signal that is frequency domain precoded in accordance with the at least portion of the frequency domain basis vector via the set of antenna ports. The operations of 1310 may be performed according to the methods described herein. In some examples, aspects of the operations of 1310 may be performed by a reference manager as described with reference to FIGS. 4 through 7. Additionally or alternatively, means for performing 1310 may, but not necessarily, include, for example, antenna 725, transceiver 720, communications manager 710, memory 730 (including code 735), processor 740 and/or bus 745.

At 1315, the UE may transmit, to the base station, a report indicating an antenna port subset of the set of antenna ports and a precoding coefficient for each antenna port of the antenna port subset. The operations of 1315 may be performed according to the methods described herein. In some examples, aspects of the operations of 1315 may be performed by a report manager as described with reference to FIGS. 4 through 7. Additionally or alternatively, means for performing 1315 may, but not necessarily, include, for example, antenna 725, transceiver 720, communications manager 710, memory 730 (including code 735), processor 740 and/or bus 745.

At 1320, the UE may receive the downlink control information that indicates a spatial domain basis vector corresponding to the frequency domain basis vector, where the reference signal is spatial domain precoded in accordance with the spatial domain basis vector. The operations of 1320 may be performed according to the methods described herein. In some examples, aspects of the operations of 1320 may be performed by a control manager as described with reference to FIGS. 4 through 7. Additionally or alternatively, means for performing 1320 may, but not necessarily, include, for example, antenna 725, transceiver 720, communications manager 710, memory 730 (including code 735), processor 740 and/or bus 745.

At 1325, the UE may receive the downlink control information that indicates an index to a precoding matrix indicator table that indicates the frequency domain basis vector and the spatial domain basis vector. The operations of 1325 may be performed according to the methods described herein. In some examples, aspects of the operations of 1325 may be performed by a control manager as described with reference to FIGS. 4 through 7. Additionally or alternatively, means for performing 1325 may, but not necessarily, include, for example, antenna 725, transceiver 720, communications manager 710, memory 730 (including code 735), processor 740 and/or bus 745.

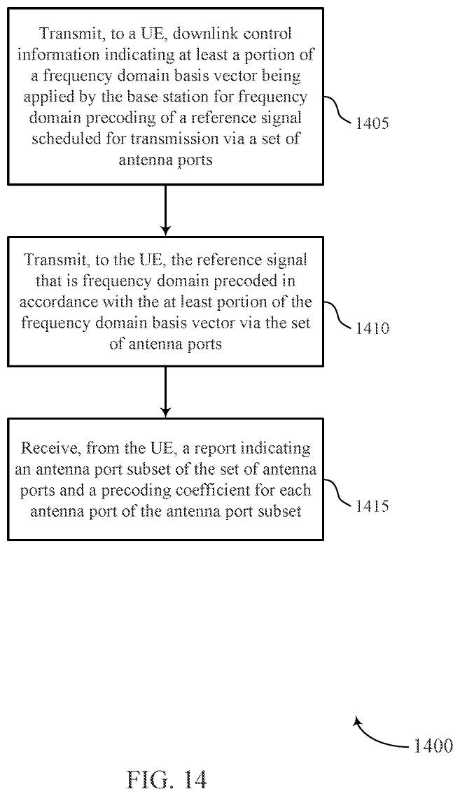

FIG. 14 shows a flowchart illustrating a method 1400 in accordance with one or more aspects of the present disclosure. The operations of method 1400 may be implemented by a base station 105 or its components as described herein. For example, the operations of method 1400 may be performed by a communications manager as described with reference to FIGS. 8 through 11. In some examples, a base station may execute a set of instructions to control the functional elements of the base station to perform the functions described herein. Additionally or alternatively, a base station may perform aspects of the functions described herein using special-purpose hardware.

At 1405, the base station may transmit, to a UE, downlink control information indicating at least a portion of a frequency domain basis vector being applied by the base station for frequency domain precoding of a reference signal scheduled for transmission via a set of antenna ports. The operations of 1405 may be performed according to the methods described herein. In some examples, aspects of the operations of 1405 may be performed by a downlink manager as described with reference to FIGS. 8 through 11. Additionally or alternatively, means for performing 1405 may, but not necessarily, include, for example, antenna 1125, transceiver 1120, communications manager 1110, memory 1130 (including code 1135), processor 1140 and/or bus 1150.

At 1410, the base station may transmit, to the UE, the reference signal that is frequency domain precoded in accordance with the at least portion of the frequency domain basis vector via the set of antenna ports. The operations of 1410 may be performed according to the methods described herein. In some examples, aspects of the operations of 1410 may be performed by a signal manager as described with reference to FIGS. 8 through 11. Additionally or alternatively, means for performing 1410 may, but not necessarily, include, for example, antenna 1125, transceiver 1120, communications manager 1110, memory 1130 (including code 1135), processor 1140 and/or bus 1150.

At 1415, the base station may receive, from the UE, a report indicating an antenna port subset of the set of antenna ports and a precoding coefficient for each antenna port of the antenna port subset. The operations of 1415 may be performed according to the methods described herein. In some examples, aspects of the operations of 1415 may be performed by an antenna manager as described with reference to FIGS. 8 through 11. Additionally or alternatively, means for performing 1415 may, but not necessarily, include, for example, antenna 1125, transceiver 1120, communications manager 1110, memory 1130 (including code 1135), processor 1140 and/or bus 1150.

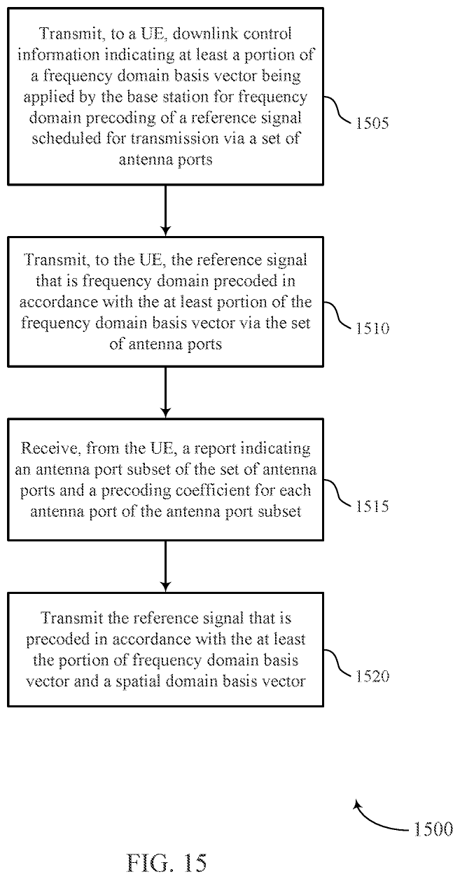

FIG. 15 shows a flowchart illustrating a method 1500 in accordance with one or more aspects of the present disclosure. The operations of method 1500 may be implemented by a base station 105 or its components as described herein. For example, the operations of method 1500 may be performed by a communications manager as described with reference to FIGS. 8 through 11. In some examples, a base station may execute a set of instructions to control the functional elements of the base station to perform the functions described herein. Additionally or alternatively, a base station may perform aspects of the functions described herein using special-purpose hardware.

At 1505, the base station may transmit, to a UE, downlink control information indicating at least a portion of a frequency domain basis vector being applied by the base station for frequency domain precoding of a reference signal scheduled for transmission via a set of antenna ports. The operations of 1505 may be performed according to the methods described herein. In some examples, aspects of the operations of 1505 may be performed by a downlink manager as described with reference to FIGS. 8 through 11. Additionally or alternatively, means for performing 1505 may, but not necessarily, include, for example, antenna 1125, transceiver 1120, communications manager 1110, memory 1130 (including code 1135), processor 1140 and/or bus 1150.

At 1510, the base station may transmit, to the UE, the reference signal that is frequency domain precoded in accordance with the at least portion of the frequency domain basis vector via the set of antenna ports. The operations of 1510 may be performed according to the methods described herein. In some examples, aspects of the operations of 1510 may be performed by a signal manager as described with reference to FIGS. 8 through 11. Additionally or alternatively, means for performing 1510 may, but not necessarily, include, for example, antenna 1125, transceiver 1120, communications manager 1110, memory 1130 (including code 1135), processor 1140 and/or bus 1150.

At 1515, the base station may receive, from the UE, a report indicating an antenna port subset of the set of antenna ports and a precoding coefficient for each antenna port of the antenna port subset. The operations of 1515 may be performed according to the methods described herein. In some examples, aspects of the operations of 1515 may be performed by an antenna manager as described with reference to FIGS. 8 through 11. Additionally or alternatively, means for performing 1515 may, but not necessarily, include, for example, antenna 1125, transceiver 1120, communications manager 1110, memory 1130 (including code 1135), processor 1140 and/or bus 1150.

At 1520, the base station may transmit the reference signal that is precoded in accordance with the at least the portion of frequency domain basis vector and a spatial domain basis vector. The operations of 1520 may be performed according to the methods described herein. In some examples, aspects of the operations of 1520 may be performed by a signal manager as described with reference to FIGS. 8 through 11. Additionally or alternatively, means for performing 1520 may, but not necessarily, include, for example, antenna 1125, transceiver 1120, communications manager 1110, memory 1130 (including code 1135), processor 1140 and/or bus 1150.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
receiving, from a network device, downlink control information indicating at least a portion of a frequency domain basis vector being applied by the network device for frequency domain precoding of a reference signal scheduled for transmission via a plurality of antenna ports;
receiving, from the network device, the reference signal that is frequency domain precoded in accordance with the at least the portion of the frequency domain basis vector via the plurality of antenna ports; and
transmitting, to the network device, a report indicating an antenna port subset of the plurality of antenna ports and a precoding coefficient for each antenna port of the antenna port subset.

2. The method of claim 1, wherein receiving the downlink control information comprises:
receiving the downlink control information that indicates a spatial domain basis vector corresponding to the frequency domain basis vector, wherein the reference signal is spatial domain precoded in accordance with the spatial domain basis vector.

3. The method of claim 2, wherein receiving the downlink control information comprises:
receiving the downlink control information that indicates an index to a precoding matrix indicator table that indicates the frequency domain basis vector and the spatial domain basis vector.

4. The method of claim 1, wherein the at least the portion of the frequency domain basis vector comprises an entirety of the frequency domain basis vector.

5. The method of claim 1, wherein a remainder of the frequency domain basis vector is preconfigured, indicated via a radio resource control message, or indicated via a medium access control (MAC) control element message.

6. The method of claim 1, further comprising:
performing a plurality of signal measurements of the reference signal, wherein each signal measurement corresponds to respective antenna port of the plurality of antenna ports; and
selecting the antenna port subset based at least in part on the plurality of signal measurements.

7. The method of claim 6, wherein the signal measurement comprises a received signal strength indicator, or a reference signal received power, or a reference signal received quality, or a signal to noise ratio, or a signal to interference plus noise ratio, or any combination thereof.

8. The method of claim 1, wherein the antenna port subset are layer-specific or layer-common.

9. The method of claim 1, wherein receiving the downlink control information further comprises:
receiving the downlink control information that indicates a set of linear combination vectors corresponding to the frequency domain basis vector.

10. The method of claim 9, further comprising:
determining the precoding coefficient for each antenna port of the antenna port subset based at least in part on the set of linear combination vectors indicated in the downlink control information.

11. The method of claim 1, further comprising:
determining a reciprocity level between an uplink channel associated with the UE and a downlink channel associated with the UE.

12. The method of claim 11, wherein the antenna port subset is selected based at least in part on the reciprocity level.

13. The method of claim 11, wherein the precoding coefficient for each antenna port of the antenna port subset is generated based at least on part on the reciprocity level.

14. The method of claim 1, wherein the antenna port subset is selected based at least in part on a basis type of the frequency domain basis vector.

15. The method of claim 14, wherein the basis type is a discrete Fourier transform basis, or a singular value decomposition basis, or a discrete cosine transform basis, or a Slepian basis, or any combination thereof.

16. The method of claim 1, further comprising:
receiving control signaling indicating a first channel precoding scheme of a plurality of channel precoding schemes, wherein the reference signal is precoded in accordance with the first channel precoding scheme.

17. The method of claim 16, wherein the control signaling comprises a radio resource control message, or a medium access control (MAC) control element message, or both.

18. A method for wireless communications at a network device, comprising:
transmitting, to a user equipment (UE), downlink control information indicating at least a portion of a frequency domain basis vector being applied by the network device for frequency domain precoding of a reference signal scheduled for transmission via a plurality of antenna ports;
transmitting, to the UE, the reference signal that is frequency domain precoded in accordance with the at least the portion of the frequency domain basis vector via the plurality of antenna ports; and
receiving, from the UE, a report indicating an antenna port subset of the plurality of antenna ports and a precoding coefficient for each antenna port of the antenna port subset.

19. The method of claim 18, wherein transmitting the downlink control information comprises:
transmitting the downlink control information that indicates a spatial domain basis vector corresponding to the frequency domain basis vector, wherein the reference signal is spatial domain precoded in accordance with the spatial domain basis vector.

20. The method of claim 19, wherein transmitting the downlink control information comprises:
transmitting the downlink control information that indicates an index to a precoding matrix indicator table that indicates the frequency domain basis vector and the spatial domain basis vector.

21. The method of claim 18, wherein the at least the portion of the frequency domain basis vector comprises an entirety of the frequency domain basis vector.

22. The method of claim 18, further comprising:
generating the frequency domain basis vector using a first basis type of a plurality of basis types; and
generating a set of linear combination vectors corresponding to the frequency domain basis vector based at least in part on the first basis type, wherein the downlink control information indicates the set of linear combination vectors.

23. The method of claim 22, wherein the plurality of basis types comprises a discrete Fourier transform basis, or a singular value decomposition basis, or a discrete cosine transform basis, or a Slepian basis, or any combination thereof.

24. The method of claim 23, further comprising:
generating a linear combination coefficient vector for the frequency domain basis vector, wherein the downlink control information indicates the linear combination coefficient vector.

25. The method of claim 24, wherein the linear combination coefficient vector comprises a single binary bit indicating a value of one and one or more binary bits indicating a value of zero when the frequency domain basis vector is generated using a discrete Fourier transform basis.

26. The method of claim 24, wherein each linear combination coefficient vector is determined by projecting the singular value decomposition basis, or the discrete cosine transform basis, or the Slepian basis, or any combination thereof, into a space of the first basis type that is the discrete Fourier transform basis.

27. The method of claim 18, further comprising:
transmitting the reference signal that is precoded in accordance with the frequency domain basis vector and a defined spatial domain basis vector.

28. The method of claim 18, further comprising:
transmitting the reference signal that is precoded in accordance with the portion of the frequency domain basis vector, a defined remainder frequency domain basis vector, and a defined spatial domain basis vector.

29. The method of claim 18, further comprising:
transmitting the reference signal that is precoded in accordance with the at least the portion of the frequency domain basis vector and a spatial domain basis vector.

30. The method of claim 18, further comprising:
transmitting control signaling indicating a first channel precoding scheme of a plurality of channel precoding schemes, wherein the reference signal is precoded in accordance with the first channel precoding scheme.

31. The method of claim 30, wherein the control signaling comprises a radio resource control message, or a medium access control (MAC) control element message, or both.

32. An apparatus for wireless communications at a user equipment (UE), comprising:
a memory;
a transceiver; and
a processor coupled with the memory and the transceiver, the processor configured to
receive, from a network device, downlink control information indicating at least a portion of a frequency domain basis vector being applied by the network device for frequency domain precoding of a reference signal scheduled for transmission via a plurality of antenna ports;
receive, from the network device, the reference signal that is frequency domain precoded in accordance with the at least the portion of the frequency domain basis vector via the plurality of antenna ports; and
transmit, to the network device, a report indicating an antenna port subset of the plurality of antenna ports and a precoding coefficient for each antenna port of the antenna port subset.

33. (canceled)

34. (canceled)

35. The apparatus of claim 32, wherein the at least the portion of the frequency domain basis vector comprises an entirety of the frequency domain basis vector.

36-48. (canceled)

49. An apparatus for wireless communications at a network device, comprising:
a memory; and
a processor coupled with the memory, the processor configured to:
transmit, to a user equipment (UE), downlink control information indicating at least a portion of a frequency domain basis vector being applied by the network device for frequency domain precoding of a reference signal scheduled for transmission via a plurality of antenna ports;
transmit, to the UE, the reference signal that is frequency domain precoded in accordance with the at least the portion of the frequency domain basis vector via the plurality of antenna ports; and
receive, from the UE, a report indicating an antenna port subset of the plurality of antenna ports and a precoding coefficient for each antenna port of the antenna port subset.

50-62. (canceled)

63. An apparatus for wireless communications at a user equipment (UE), comprising:
means for receiving, from a network device, downlink control information indicating at least a portion of a frequency domain basis vector being applied by the network device for frequency domain precoding of a reference signal scheduled for transmission via a plurality of antenna ports;
means for receiving, from the network device, the reference signal that is frequency domain precoded in accordance with the at least the portion of the frequency domain basis vector via the plurality of antenna ports; and
means for transmitting, to the network device, a report indicating an antenna port subset of the plurality of antenna ports and a precoding coefficient for each antenna port of the antenna port subset.

64-66. (canceled)
